(19) United States
(12) Patent Application Publication
(10) Pub. No.: US 2025/0306366 A1
(43) Pub. Date: Oct. 2, 2025

(54) IMAGE GENERATING APPARATUS AND IMAGE PROJECTING APPARATUS

(71) Applicant: KOITO MANUFACTURING CO., LTD., Tokyo (JP)

(72) Inventors: Takanobu TOYOSHIMA, Shizuoka (JP); Keiichiro NOMURA, Shizuoka (JP)

(21) Appl. No.: 19/235,574

(22) Filed: Jun. 12, 2025

Related U.S. Application Data
(63) Continuation of application No. PCT/JP2023/044140, filed on Dec. 11, 2023.

(30) Foreign Application Priority Data
Dec. 16, 2022 (JP) 2022-201376

(51) Int. Cl. G02B 27/01

(52) U.S. Cl. CPC G02B 27/0101; G02B 27/0179; G02B 2027/014; G02B 2027/0181

(57) ABSTRACT

An image generating apparatus is provided in a vehicle to generate a predetermined image. The image generating apparatus includes: a liquid crystal unit; a plurality of light sources divided into a plurality of sections; and a control unit that performs local dimming control to turn ON and OFF the plurality of light sources for each of the plurality of sections. The control unit changes a section to be turned OFF according to a viewpoint of an occupant of the vehicle.

### CROSS REFERENCE TO RELATED APPLICATIONS

This application is a continuation application of International Patent Application No. PCT/JP2023/044140, filed on Dec. 11, 2023, which claims priority from Japanese Patent Application No. 2022-201376, filed on Dec. 16, 2022, with the Japan Patent Office, the disclosures of which are incorporated herein in their entireties by reference.

### TECHNICAL FIELD

The present disclosure relates to an image generating apparatus and an image projecting apparatus.

### BACKGROUND

A head-up display (HUD) is known as a form of visual communication between a vehicle and an occupant (e.g., a driver) of the vehicle. The head-up display projects an image onto a windshield or combiner, and allows the occupant to visually perceive the image superimposed on the real space through the windshield or combiner, thereby implementing augmented reality (AR).

International Patent Publication No. 2022/019048 discloses an image generating apparatus that generates an image for a head-up display. The image generating apparatus includes a light source, a liquid crystal device, an optical element, and an optical member. The liquid crystal device has a rectangular display area and generates an image using light emitted from the light source. The optical element irradiates the liquid crystal device with the light emitted from the light source. The optical member reduces light corresponding to at least one side of the display area. The liquid crystal device may have a plurality of display areas.

### SUMMARY

Local dimming is known in which a light source is divided into a plurality of sections for the individual control of the light source corresponding to each section. Local dimming lowers the brightness of the light source corresponding to the section that needs to be dimmed, thereby minimizing the heat generation and power consumption of a host device.

Local dimming is also employed in a head-up display. In this case, the head-up display may turn ON some of a plurality of light sources included in an image generating apparatus, while also turning OFF others, per section. Light controlled in this manner is emitted from the image generating apparatus, and is guided to the occupant's viewpoint by way of a windshield or combiner of a vehicle. However, the vehicle occupant's viewpoint is not always at a predetermined position, and there may be cases where the light does not appropriately reach the occupant's viewpoint. Furthermore, the inventors have considered whether it is possible to further increase the number of light sources that may be turned OFF through local dimming.

The present disclosure provides an image generating apparatus and an image projecting apparatus for controlling a light source according to the viewpoint of a vehicle occupant.

An image generating apparatus of the present disclosure is an image generating apparatus provided in a vehicle to generate a predetermined image, the image generating apparatus including a liquid crystal unit, a plurality of light sources divided into a plurality of sections, and a control unit that performs local dimming control to turn ON and OFF the plurality of light sources for each of the plurality of sections. The control unit changes the section to be turned OFF according to a viewpoint of an occupant of the vehicle.

An image projecting apparatus of the present disclosure is an image projecting apparatus provided in a vehicle to display a predetermined image toward an occupant of the vehicle, the image projecting apparatus including the image generating apparatus described above and a reflection mirror that reflects light emitted from the image generating apparatus.

According to the present disclosure, it is possible to provide an image generating apparatus and an image projecting apparatus for controlling a light source according to the viewpoint of a vehicle occupant.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram of a vehicle system in a vehicle equipped with a head-up display (HUD) according to the present disclosure.

FIG. 2 is a diagram of the HUD according to the present disclosure.

FIG. 3 is a block diagram of an image generation unit of the HUD.

FIG. 4 is a schematic diagram illustrating the turning ON and OFF of a plurality of light sources of the image generation unit.

FIG. 5 is a schematic diagram illustrating an image visually perceived by an occupant.

FIG. 6 is a schematic diagram illustrating the occupant's viewpoint detected by an internal camera.

FIG. 7 is a schematic diagram illustrating local dimming control by a control unit of the image generation unit when the occupant's viewpoint is located near the center of an eye box.

FIG. 8 is a schematic diagram illustrating local dimming control by the control unit of the image generation unit after the occupant's viewpoint moves from the state of FIG. 7.

### DETAILED DESCRIPTION

In the following detailed description, reference is made to the accompanying drawings, which form a part thereof. The illustrative embodiments described in the detailed description, drawings, and claims are not meant to be limiting. Other embodiments may be utilized, and other changes may be made without departing from the spirit or scope of the subject matter presented here.

Hereinafter, an embodiment (hereinafter, also referred to as the present embodiment) of the present disclosure will be described with reference to the drawings. The dimension of each member illustrated in the drawings may differ from the actual dimension of each member for the convenience of description.

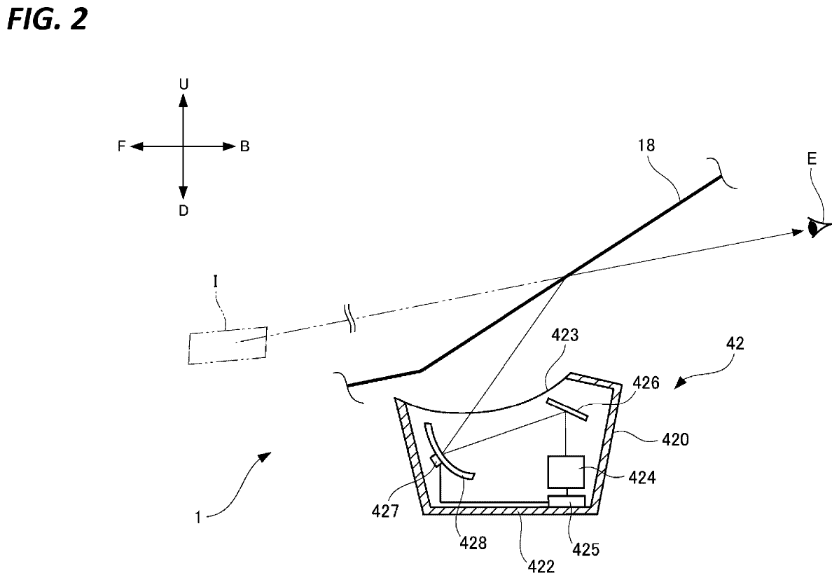

In the description of the present embodiment, terms “left-right direction,” “up-down direction,” and “front-back direction” may be appropriately mentioned for the convenience of description. These directions are relative directions set for a head-up display (HUD) 42 illustrated in FIG. 2. Here, the “left-right direction” includes both the “leftward direction” and the “rightward direction.” The “up-down direction” includes both the “upward direction” and the “downward direction.” The “front-back direction” includes both the “forward direction” and the “backward direction.” The left-right direction is perpendicular to both the up-down direction and the front-back direction, although not illustrated in FIG. 2. These directions are defined on the basis of an occupant who uses the HUD 42.

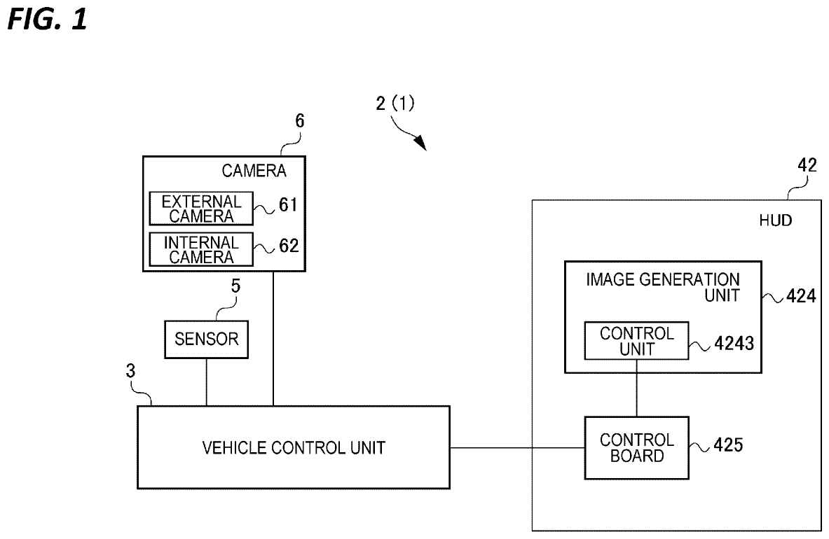

Referring to FIG. 1, a vehicle system 2 in a vehicle 1 equipped with the head-up display (HUD) 42 according to the present embodiment will be described below. FIG. 1 is a block diagram of the vehicle system 2.

As illustrated in FIG. 1, the vehicle system 2 includes a vehicle control unit 3, the HUD 42, a sensor 5, and a camera 6.

The vehicle control unit 3 is configured to control the traveling of the vehicle 1. The vehicle control unit 3 is made up of, for example, at least one electronic control unit (ECU). The electronic control unit includes a computer system including one or more processors and one or more memories (e.g., a System on a Chip (SoC)) and an electronic circuit made up of active elements such as transistors and passive elements. The processors include, for example, at least one of a central processing unit (CPU), a micro processing unit (MPU), a graphics processing unit (GPU), and a tensor processing unit (TPU). The CPU may be made up of multiple CPU cores. The GPU may be made up of multiple GPU cores. The memories include a read only memory (ROM) and a random access memory (RAM). The ROM may store a vehicle control program. For example, the vehicle control program may include an artificial intelligence (AI) program for autonomous driving. The AI program is a program (trained model) constructed through supervised or unsupervised machine learning (particularly deep learning) using a multilayer neural network. The RAM may temporarily store the vehicle control program, vehicle control data, and/or surrounding environment information indicating the vehicle's surrounding environment. The processors may be configured to load a designated program from various vehicle control programs stored in the ROM into the RAM and execute various processing tasks in cooperation with the RAM. Further, the computer system may also be configured using a non-von Neumann computer such as an application specific integrated circuit (ASIC) or a field-programmable gate array (FPGA). Furthermore, the computer system may also be configured with a combination of a von Neumann computer and a non-von Neumann computer.

The HUD 2 is at least partially located in the interior of the vehicle 1. Specifically, the HUD 42 is installed at a predetermined location in the cabin of the vehicle 1. For example, the HUD 42 may be arranged within a dashboard of the vehicle 1. The HUD 42 serves as a visual interface between the vehicle 1 and the occupant. The HUD 42 is configured to display predetermined information (hereinafter, referred to as “HUD information”) toward the occupant in such a manner that the HUD information is superimposed onto the real space outside the vehicle 1 (particularly the surrounding environment ahead of the vehicle). In this way, the HUD 42 is an augmented reality (AR) display. The HUD information displayed by the HUD 42 includes, for example, vehicle traveling information related to the traveling of the vehicle 1 and/or surrounding environment information related to the surrounding environment of the vehicle 1 (particularly information related to objects existing outside the vehicle 1). Details of the HUD 42 will be described later. The HUD 42 is an example of an image projecting apparatus.

In the present embodiment, the vehicle control unit 3 and a control board 425 of the HUD 42, which will be described later, are provided as separate components, but the vehicle control unit 3 and the control board 425 may also be integrally configured. In this regard, the control board 425 and the vehicle control unit 3 may be configured with a single electronic control unit. A control unit 4243 of an image generation unit 424 of the HUD 42, which will be described later, may be configured as a part of the control board 425.

The sensor 5 includes at least a vehicle speed sensor that detects the speed of the vehicle 1 and outputs speed information, which is the detection result, to the vehicle control unit 3. In addition to the vehicle speed sensor, the sensor 5 may further include an acceleration sensor, a gyro sensor, a seat occupancy sensor that detects whether the driver is seated in the driver's seat, a face orientation sensor that detects the orientation of the driver's face, an outside weather sensor that detects outside weather conditions, and a human presence sensor that detects whether a person is present in the vehicle cabin.

The camera 6 is, for example, a camera including an imaging device such as a charge-coupled device (CCD) or complementary MOS (CMOS). The camera 6 includes one or more external and internal cameras 61 and 62. The external camera 61 is configured to acquire image data indicating the surrounding environment of the vehicle 1, and then output the image data to the vehicle control unit 3. The vehicle control unit 3 acquires surrounding environment information based on the transmitted image data. Here, the surrounding environment information may include information about objects (such as pedestrians, other vehicles including a preceding vehicle, and road signs) present outside the vehicle 1. More specifically, the external camera 61 detects a preceding vehicle traveling ahead of the vehicle 1 and outputs image data indicating the preceding vehicle to the vehicle control unit 3. The vehicle control unit 3 acquires surrounding environment information, including information about the preceding vehicle and information about the distance and position of the preceding vehicle relative to the vehicle 1, based on the transmitted image data. The external camera 61 may be configured as a monocular camera or as a binocular camera. The external camera 61 is an example of a vehicle detector. The surrounding environment information is an example of preceding vehicle information.

The internal camera 62 is arranged in the interior of the vehicle 1 and is configured to acquire image data indicating the occupant. The internal camera 62 functions as a tracking camera that tracks the occupant's viewpoint E. The internal camera 62 may also have a light projection function, an image processing function, and an arithmetic processing function required for tracking. Here, the occupant's viewpoint E refers to either the left eye viewpoint or the right eye viewpoint of the occupant. The viewpoint E may also be defined as the midpoint of a line segment connecting the left eye viewpoint and the right eye viewpoint. In the present embodiment, the occupant's viewpoint E is assumed to be the occupant's left eye viewpoint. The vehicle control unit 3 may identify the position of the occupant's viewpoint E based on the image data acquired by the internal camera 62. The position of the occupant's viewpoint E is updated at a predetermined cycle based on the image data.

Next, details of the HUD 42 will be described. FIG. 2 is a diagram of the HUD 42 according to the present disclosure. In FIG. 2, the occupant's left-eye viewpoint is represented as the occupant's viewpoint E.

As illustrated in FIG. 2, the HUD 42 includes a HUD main body 420. The HUD main body 420 includes a housing 422 and an emission window 423. The emission window 423 is a transparent plate that transmits visible light. The HUD main body 420 includes, inside the housing 422, the image generation unit 424, the control board 425, a planar mirror 426, a drive mechanism 427, and a concave mirror 428.

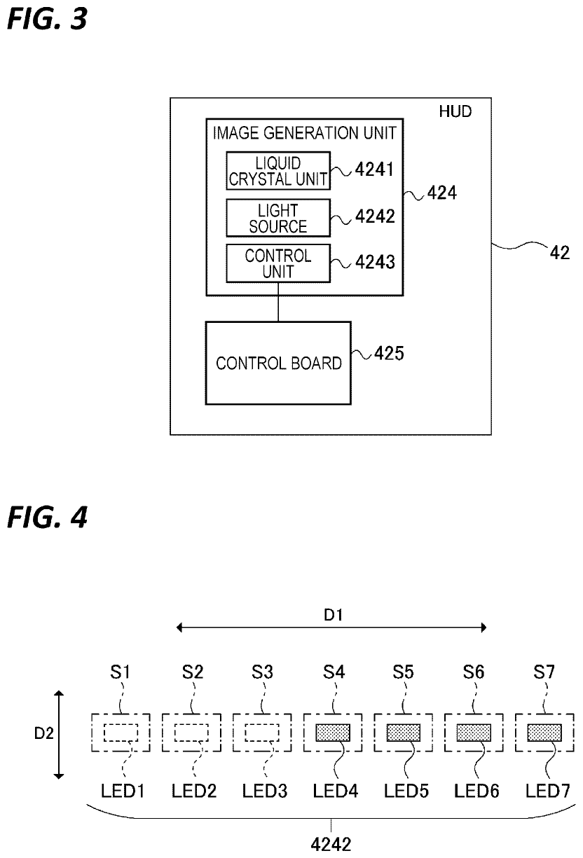

The image generation unit 424 is configured to generate a predetermined image. FIG. 3 is a block diagram of the image generation unit 424. As illustrated in FIG. 3, the image generation unit 424 includes a liquid crystal unit 4241, a plurality of light sources 4242, and the control unit 4243. Each of the plurality of light sources 4242 is, for example, an LED light source. In the present embodiment, the liquid crystal unit 4241 is a liquid crystal display. Alternatively, the liquid crystal unit 4241 may be configured with a digital mirror device (DMD) or similar one. The drawing method of the image generation unit 424 may be a DLP method or an LCOS method. When the liquid crystal unit 4241 is a liquid crystal display, each of the plurality of light sources 4242 may be a white LED light source. The image generation unit 424 is an example of an image generating apparatus.

The liquid crystal unit 4241 of the image generation unit 424 is formed with an image forming surface made up of a large number of pixels. The image generation unit 424 is configured to form an image using a part of the image forming surface. Furthermore, the image generation unit 424 is configured to change the positions of pixels forming the image, thereby changing the display position of the image.

The control unit 4243 is configured to control the operation of the image generator 424. In the present embodiment, the plurality of light sources 4242 are divided into a plurality of sections, and the control unit 4243 is configured to perform local dimming control by turning ON and OFF the plurality of light sources 4242 for each section. Details of the local dimming control will be described later. The control unit 4243 is configured with an electronic control unit (ECU). The electronic control unit includes a computer system (e.g., SoC) including one or more processors and one or more memories, and an electronic circuit made up of active elements such as transistors and passive elements. The processors include at least one of a CPU, MPU, GPU, and TPU. The memories includes a ROM and a RAM. Further, the computer system may be configured with a non-von Neumann computer such as an ASIC or FPGA.

Returning to FIG. 2, the description of the HUD 42 will be continued. The control board 425 is configured to control the operation of the image generation unit 424 (control unit 4243) and the drive mechanism 427. The control board 425 is equipped with a processor such as a central processing unit (CPU) and a memory, and the processor executes a computer program read from the memory to control the operation of the image generation unit 424. The control board 425 may also control the drive mechanism 427 to change the orientation (angle) of the concave mirror 428.

The control board 425 acquires information and image data transmitted from the vehicle control unit 3. The acquired information or image data includes at least viewpoint information about the occupant's viewpoint E. The control board 425 is further configured to generate a control signal for controlling the operation of the image generation unit 424 based on the information and image data, and to transmit the generated control signal to the control unit 4243 of the image generation unit 424. More specifically, the control board 425 is configured to control the display position of the image generated by the image generation unit 424 according to the acquired information and image data.

The concave mirror 428 is arranged on the optical path of light emitted from the image generation unit 424 and reflected by the planar mirror 426. Specifically, the concave mirror 428 is positioned in front of the image generation unit 424 and the planar mirror 426 inside the HUD main body 420. The concave mirror 428 is configured to reflect the light emitted by the image generation unit 424 toward a windshield 18 (e.g., a front window of the vehicle 1) through the emission window 423. The concave mirror 428 has a concavely curved reflective surface and reflects an image formed by the light emitted from the image generation unit 424 at a predetermined magnification. The planar mirror 426 and the concave mirror 428 are an example of a reflective mirror.

The windshield 18 is irradiated with the light emitted from the emission window 423 of the HUD main body 420. A part of the light from the HUD main body 420 onto the windshield 18 is reflected toward the occupant's viewpoint E. As a result, the occupant perceives the light emitted from the HUD main body 420 (predetermined image) as a virtual image formed at a predetermined distance in front of the windshield 18. In this way, the image displayed by the HUD 42 is superimposed onto the real space ahead of the vehicle 1 through the windshield 18, allowing the occupant to visually perceive a virtual image object I formed by the predetermined image as if it were floating on the road outside the vehicle.

When a 2D image (planar image) is to be formed as the virtual image object I, a predetermined image is projected to form a virtual image at a single arbitrarily defined distance. When a 3D image (stereoscopic image) is to be formed as the virtual image object I, multiple predetermined images, which are the same or different from each other, are projected to form virtual images at different distances, respectively. Further, the distance of the virtual image object I (the distance from the occupant's viewpoint E to the virtual image) is adjustable by adjusting the distance from the image generation unit 424 to the occupant's viewpoint E (e.g., by adjusting the distance between the image generation unit 424 and the concave mirror 428). Further, the HUD main body 420 may not include the planar mirror 426. In this case, the light emitted from the image generation unit 424 is incident on the concave mirror 428 without being reflected by the planar mirror 426.

Next, the plurality of light sources 4242 will be described.

FIG. 4 is a schematic diagram illustrating the turning ON and OFF of the plurality of light sources 4242.

As illustrated in FIG. 4, the plurality of light sources 4242 are divided into a plurality of sections S1 to S7. In the present embodiment, the plurality of light sources 4242 include LED 1, LED 2, LED 3, LED 4, LED 5, LED 6, and LED 7. LED 1 is arranged in section S1. LED 2 is arranged in section S2. LED 3 is arranged in section S3. LED 4 is arranged in section S4. LED 5 is arranged in section S5. LED 6 is arranged in section S6. LED 7 is arranged in section 7. In this way, in the present embodiment, one LED is arranged in each section.

The plurality of sections S1 to S7 are arranged in a first direction D1 and a second direction D2. The number of sections arranged in the first direction D1 is greater than the number of sections arranged in the second direction D2. In the present embodiment, the number of sections arranged in the first direction D1 is seven. The number of sections arranged in the second direction D2 is one. That is, in the present embodiment, the plurality of sections S1 to S7 are arranged in a row along the first direction D1. In FIG. 4, section S4 (LED 4) is located at the center in the first direction D1, with sections S1, S2, and S3 (LEDs 1, 2, and 3) arranged on the left, and sections S5, S6, and S7 (LEDs 5, 6, and 7) arranged on the right.

In FIG. 4, LEDs that are in the ON state are represented with solid lines and filled-in shading, while LEDs that are in the OFF state are represented with dashed lines. In FIG. 4, as an example of the turning ON and OFF the plurality of light sources 4242, LEDs 1, 2, and 3 are in the OFF state, and LEDs 4, 5, 6, and 7 are in the ON state.

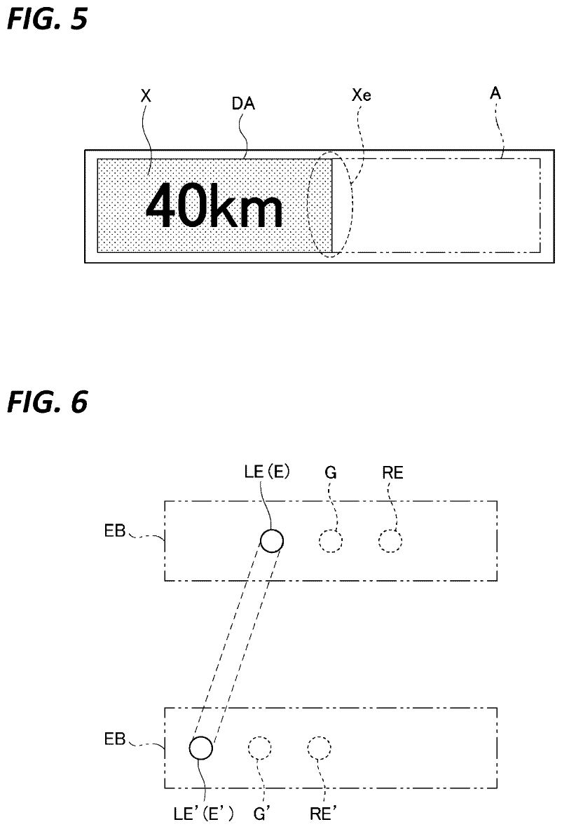

FIG. 5 is a schematic diagram illustrating an image visually perceived by the occupant. As illustrated in FIG. 5, an image X is displayed in a part of an image generatable area A, which is an area capable of generating a predetermined image. Here, the image X is displayed in a display area DA (the left half in FIG. 5), which occupies half of the image generatable area A. The image X may, for example, represent speed information on the vehicle 1. In addition, the image generated by the image generation unit 424 is not limited to the speed information.

In the present embodiment, when LEDs 1 to 3 in sections S1 to S3 located on the left are turned OFF, and LEDs 4 to 7 in sections S4 to S7 in the center and the right are turned ON (see, e.g., FIG. 4), the image X is displayed in the display area DA, which is the left half of image generatable area A, and nothing is displayed in the other area (see, e.g., FIG. 5). In this way, the image generation unit 424 is configured to form a single virtual image using light emitted from multiple sections.

Next, the internal camera 62 that tracks the occupant's viewpoint E will be described.

FIG. 6 is a schematic diagram illustrating the occupant's viewpoint E detected by the internal camera 62. As illustrated in FIG. 6, the internal camera 62 is configured to detect the movement of the occupant's viewpoint E. The internal camera 62 is configured to detect the left eye viewpoint LE and right eye viewpoint RE of the occupant and the glabella G, which is the midpoint of a line segment connecting these viewpoints LE and RE. In the present embodiment, the occupant's viewpoint E is defined as the occupant's left eye viewpoint LE. In FIG. 6, the viewpoint LE is represented by a solid line, while the viewpoint RE and the glabella G are represented by dashed lines.

The internal camera 62 defines an eye box EB as a detectable area. The eye box EB is fixed according to the position where the internal camera 62 is attached to the vehicle 1. The eye box EB is, for example, rectangular. In the present embodiment, the longitudinal direction of the eye box EB corresponds to the first direction D1 of the plurality of light sources 4242. When the internal camera 62 detects the left eye viewpoint LE, the right eye viewpoint RE, and the glabella G within the eye box EB, it transmits, as image data, the eye box EB including the viewpoint LE, the viewpoint RE, and the glabella G to the vehicle control unit 3. The vehicle control unit 3 may identify the positions of the viewpoint LE, the viewpoint RE and the glabella G, for example, as coordinates within the eye box EB, based on the image data received from the internal camera 62.

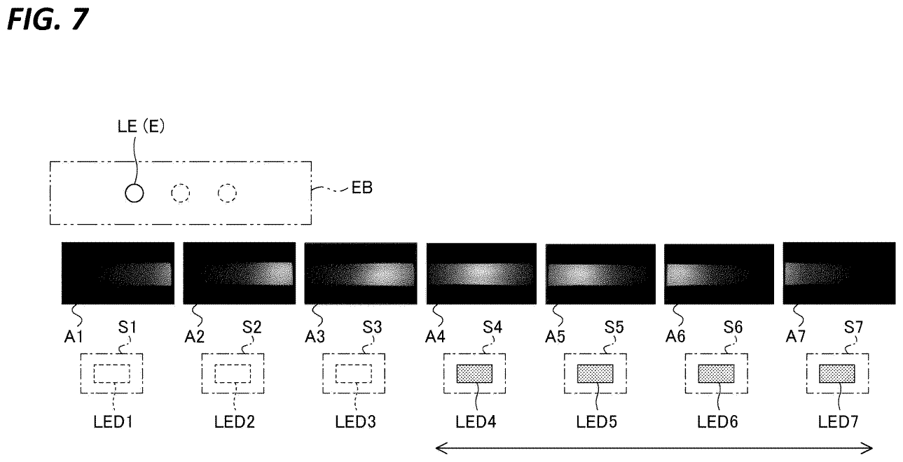

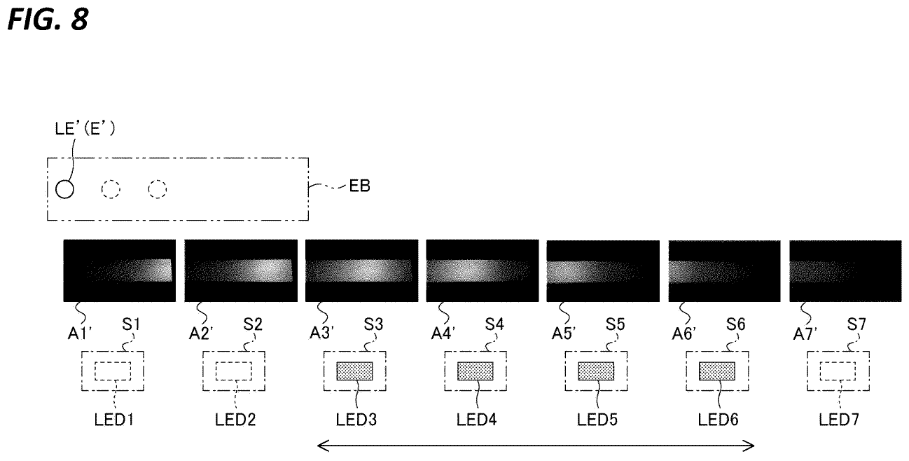

Next, the operation of the control unit 4243 of the image generation unit 424 will be described with reference to FIGS. 7 and 8.

FIG. 7 illustrates the ON/OFF state of the plurality of light sources 4242 when the occupant left eye viewpoint LE is positioned near the center of the eye box EB. FIG. 8 is a schematic diagram illustrating local dimming control of the control unit 4243 after the occupant's viewpoint E moves from the state of FIG. 7. FIG. 8 illustrates the ON/OFF state of the plurality of light sources 4242 when the occupant's left eye viewpoint LE' is positioned on the left side within the eye box EB.

FIG. 7 illustrates an image visually perceived by the occupant when an LED corresponding to one section is turned ON, and LEDs corresponding to the other sections are turned OFF. In addition, in practice, the occupant visually perceives a composite image formed by images from all sections.

For example, Al at the left end of FIG. 7 represents an image visually perceived by the occupant when LED 1 arranged in section S1 is turned ON, and LEDs 2 to 7 arranged in the other sections S2 to S7 are turned OFF. Similarly, A2, the second from the left end in FIG. 7 represents an image visually perceived by the occupant when LED 2 arranged in section S2 is turned ON, and LEDs 1 and 3 to 7 arranged in the other sections S1 and S3 to S7 are turned OFF. A3, the third from the left end in FIG. 7, represents an image visually perceived by the occupant when LED 3 arranged in section S3 is turned ON, and LEDs 1, 2, and 4 to 7 arranged in the other sections S1, S2, and S4 to S7 are turned OFF. A4, the fourth from the left end in FIG. 7 represents an image visually perceived by the occupant when LED 4 arranged in section S4 is turned ON, and LEDs 1 to 3 and 5 to 7 arranged in the other sections S1 to S3 and S5 to S7 are turned OFF. A5, the fifth from the left end in FIG. 7 represents an image visually perceived by the occupant when LED 5 arranged in section S5 is turned ON, and LEDs 1 to 4, 6, and 7 arranged in the other sections S1 to S4, S6, and S7 are turned OFF. A6, the sixth from the left end in FIG. 7, represents an image visually perceived by the occupant when LED 6 arranged in section S6 is turned ON, and LEDs 1 to 5 and 7 arranged in the other sections S1 to S5 and S7 are turned OFF. A7, the seventh from the left end in FIG. 7, represents an image visually perceived by the occupant when LED 7 arranged in section S7 is turned ON, and LEDs 1 to 6 arranged in the other sections S1 to S6 are turned OFF.

The three images from the left end in FIG. 7 are images with a dimmed left half. This indicates that even when LEDs 1 to 3 in sections S1 to S3 are turned ON, the contribution of light emitted from these LEDs 1 to 3 to an image visually perceived by the occupant is not significant when attempting to form an image in the display area DA, which occupies the left half of the image generatable area A as illustrated in FIG. 5. Therefore, when the viewpoint LE is located near the center in the longitudinal direction of the eye box EB, turning OFF LEDs 1 to 3 in sections S1 to S3 has little effect on the image visually perceived by the occupant when displaying the image as illustrated in FIG. 5. In other words, when the occupant's viewpoint LE is located near the center, turning ON LEDs 4 to 7 in sections S4 to S7 is sufficient to allow the occupant to clearly visually perceive the image in FIG. 5 even when LEDs 1 to 3 in sections S1 to S3 are turned OFF. In this way, the power consumption of the image generation unit 424 may be reduced by turning OFF an LED in a specific section that has minimal impact on the image visually perceived by the occupant. This method of controlling the turning ON and OFF of LEDs based on the contribution to the visually perceived image is referred to as local dimming control.

However, the occupant's viewpoint LE may move within the eye box. Therefore, the sections in which LEDs may be turned OFF without significantly affecting the image visually perceived by the occupant may change. A1′ to A7′ in FIG. 8 represent images visually perceived by the occupant when each section is turned ON individually after the occupant's viewpoint LE' moves from near the center to the left side in the longitudinal direction of the eye box EB. According to FIG. 8, even when LEDs 1, 2, and 7 in sections S1, S2, and S7 are turned OFF, the occupant may still sufficiently visually perceive an image like that illustrated in FIG. 5 by turning ON LEDs 3 to 6 in sections S3 to S6. In this way, among the plurality of sections, which sections may have LEDs turned OFF depend on the position of the occupant's viewpoint LE, and sections to be turned OFF change according to the occupant's viewpoint LE.

When the occupant's left eye viewpoint LE is located near the center of the eye box EB (see, e.g., FIG. 7), the number of sections to be turned ON is four. In this case, the positions of the sections to be turned ON are the fourth, fifth, sixth, and seventh sections S4, S5, S6, and S7 from the left among the seven sections arranged in a row. The number of sections to be turned ON is four. In this case, the positions of the sections to be turned ON are the fourth, fifth, sixth, and seventh sections S4, S5, S6, and S7 from the left end among the seven sections arranged in a row.

When the occupant's left eye viewpoint LE' is located on the left side of the eye box EB (see, e.g., FIG. 8), the number of sections to be turned ON is four. In this case, the positions of the sections to be turned ON are the third, fourth, fifth, and sixth sections S3, S4, S5, and S6 from the left end among the seven sections arranged in a row. In this way, when the occupant's viewpoint E moves, the positions of the section to be turned ON shifts in the direction in which the sections are arranged in a row (the first direction D1 of the plurality of light sources 4242).

As described above, in the present embodiment, in order to change a section to be turned OFF according to the viewpoint E of the vehicle occupant, a light source corresponding to a section to be dimmed is turned OFF. One example of changing the section is changing the position of a section to be turned ON. Therefore, it is possible to realize an image generation unit that minimizes heat generation and energy consumption while also providing an image X to the occupant with the same brightness as before movement of the viewpoint E even when the occupant's viewpoint E moves. Furthermore, it is possible to realize an image projecting apparatus including such an image generation unit.

In addition, in the above-described embodiment, an example was described in which an image is formed in the display area DA occupying the left half of the image generatable area A. However, in practice, the image may be formed at any location within the image generatable area A. In this case, a section that has little effect on an image visually perceived by the occupant depends on the position where an image is to be formed. The control unit 4243 identifies a section that has little effect on the image visually perceived by the occupant according to the position in the image generatable area A where an image is to be displayed, then changes the identified section according to the occupant's viewpoint E, and turns OFF the LED in the section.

In the present embodiment, the plurality of sections S1 to S7 are divided along the first direction D1 and the second direction D2, with a greater number of sections arranged in the first direction D1 than that in the second direction D2. When the occupant's viewpoint E moves, the position of the section to be turned ON shifts in the first direction D1 where a greater number of sections are arranged. In other words, since a greater number of sections may be turned OFF, heat generation and energy consumption may be further minimized.

In the above embodiment, one LED is arranged per section, but the number of LEDs arranged in one section is not limited to one. Multiple LEDs may be arranged in a single section. In this case, the control unit 4243 may collectively control the ON/OFF states of the multiple LEDs per section. That is, when multiple LEDs are arranged in a single section, the control unit 4243 controls all the multiple LEDs included in the single section to be either turned ON or OFF. Further, each of the plurality of light sources 4242 is not limited to an LED light source. For example, each light source may be configured as an RGB laser light source that emits each of red, green, and blue laser light, and each color laser light source may be arranged in a single section. Even in such a case, the control unit 4243 may control all color laser light sources in a single section to be either turned ON or OFF.

In the above embodiment, only one section was arranged in the second direction D2, but multiple LEDs 4242 may also be arranged in the second direction D2. The numbers of sections arranged in the first direction D1 and the second direction D2 are not limited to seven and two, respectively.

In the above embodiment, the image X was displayed in the display area DA occupying half (the left half in FIG. 5) of the image generatable area A in one direction, but the position and range of the display area DA are not limited thereto. For example, the image X may be displayed in a display area occupying the other half (the right half in FIG. 5) of the image generatable area A in one direction. The image X may also be displayed in a display area occupying one third of the image generatable area A in one direction. Alternatively, the image X may be displayed in multiple display areas within the image generatable area A.

In the above embodiment, the number of sections to be turned ON was four both before and after the movement of the occupant's viewpoint E, but the number of sections to be turned ON may change. For example, when it is not necessary to increase the brightness of an edge Xe (see, e.g., FIG. 5) of the image X displayed in the display area DA when the occupant's viewpoint E moves, i.e., when the edge Xe may be dimmer than the image X without affecting the occupant's visibility within an acceptable range, it may not necessary to turn ON the LED in the section corresponding to the edge Xe. In such a case, the number of sections to be turned ON may be four before the occupant's viewpoint E moves, but may be only three after the occupant's viewpoint E moves. In this way, since the number of sections to be turned ON may change when the occupant's viewpoint E moves, the heat generation and energy consumption of the image generation unit 424 may be further minimized.

In the above embodiment, the occupant's viewpoint E was described as the occupant's left eye viewpoint LE, but may also be the occupant's right eye viewpoint RE. In the above embodiment, the occupant's viewpoint E was described as a single point (monocular) but is not limited thereto. The occupant's viewpoint E may be defined, for example, as the glabella G, which is a composite of the left eye viewpoint LE and the right eye viewpoint RE.

From the foregoing, it will be understood that various examples of the present disclosure are described for illustrative purposes, and that various variations may be made without departing from the scope and idea of the present disclosure. Therefore, the various examples disclosed herein are not intended to limit the essential scope and ideas designated by each of the following claims.

What is claimed is:

1. An image generating apparatus comprising:
a liquid crystal panel;
a plurality of light sources divided into a plurality of sections; and
a controller configured to perform a local dimming control to turn ON and OFF the plurality of light sources for each of the plurality of sections, thereby generating a predetermined image in a vehicle,
wherein the controller changes a section to be turned OFF according to a viewpoint of an occupant of the vehicle.

2. The image generating apparatus according to claim 1, wherein a position of a section to be turned ON shifts when the viewpoint of the occupant moves.

3. The image generating apparatus according to claim 2, wherein the plurality of sections are arranged in a first direction and a second direction,
a number of the plurality of sections arranged in the first direction is greater than a number of the plurality of sections arranged in the second direction, and
the position of the section to be turned ON shifts in the first direction when the viewpoint of the occupant moves.

4. The image generating apparatus according to claim 1, wherein a number of the sections to be turned ON changes when the viewpoint of the occupant moves.

5. An image projecting apparatus comprising:
the image generating apparatus according to claim 1; and
a reflection mirror configured to reflect light emitted from the image generating apparatus, thereby generating a predetermined image in a vehicle toward an occupant of the vehicle.
